(19) United States
(12) Patent Application Publication
(10) Pub. No.: US 2013/0101809 A1
(43) Pub. Date: Apr. 25, 2013

(54) Sequentially Primed Printed Substrate

(71) Applicant: THE PROCTER & GAMBLE COMPANY, Cincinnati, OH (US)

(72) Inventors: Christian Kohlweyer, Schwalbach am Taunus (DE); Christain Weber, Schwalbach am Taunus (DE)

(73) Assignee: THE PROCTER & GAMBLE COMPANY, Cincinnati, OH (US)

(21) Appl. No.: 13/660,225

(22) Filed: Oct. 25, 2012

Related U.S. Application Data
(60) Provisional application No. 61/551,260, filed on Oct. 25, 2011.

(51) Int. Cl. B32B 27/06; B32B 33/00; B05D 1/38

(52) U.S. Cl. 428/195.1; 427/487

(57) ABSTRACT

A sequentially primed printed substrate and method of forming the printed substrate are provided. The substrate is formed by the steps of: 1) providing a film printed with one or more layers of ink; 2) applying a layer of primer to the ink and/or film; 3) drying or curing the layer of primer; 4) applying a layer of radiation-curable varnish to the primer-coated film; and 5) curing the varnish.

### FIELD OF THE INVENTION

The present invention relates generally to printed substrates used to form packages, adhesive tapes, adhesive and non-adhesive labels and sleeves, wall coverings, surface coverings, surface linings, decorative tapes, pouches, envelopes, wraps, and labels. In particular, this invention is related to sequentially primed printed substrates.

### BACKGROUND OF THE INVENTION

There are a variety of types of packages in which consumer products are delivered to consumers. For many products, the package not only functions as a practical means for transporting and storing the product but also serves as a communication link between the seller and the consumer. Indicia such as labeling, stylized graphics, use of color and contrast, and touch and feel are all signals that can help consumers select the products they desire and forge a strong bond between the consumers and the brands of goods they purchase.

Special packaging and labels have been created to increase the visual impact on consumers. While some visual effects, such as holographic effects, result in strong visual impact, they are also expensive to produce. Therefore, a need still exists for packaging that gives a strong visual impact at a more economical cost.

### SUMMARY OF THE INVENTION

A sequentially primed printed substrate and method of forming the printed substrate are provided. The resulting printed substrate can give a strong visual impact for product packaging. The substrate is formed by the steps of: 1) providing a film printed with one or more layers of ink; 2) applying a layer of primer to the ink and/or film; 3) drying or curing the layer of primer; 4) applying a layer of radiation-curable varnish to the primer-coated film; and 5) curing the varnish.

### BRIEF DESCRIPTION OF THE DRAWINGS

While the specification concludes with claims particularly pointing out and distinctly claiming the subject matter that is regarded as forming the present invention, it is believed that the invention will be better understood from the following description taken in conjunction with the accompanying drawings, in which:

FIG. 1 is a cross sectional view of a sequentially primed printed substrate in which the printed layers are located between the film and a primer layer.

FIG. 2 is an exploded cross sectional view of the sequentially primed printed substrate of FIG. 1.
FIG. 3 is a cross sectional view of a sequentially primed printed substrate in which the film layer is located between the printed layers and the primer layer.

FIG. 4 is an exploded cross sectional view of the sequentially primed printed substrate of FIG. 3.

The accompanying drawings are not to scale with respect to any dimension. In general, the thickness of any application of ink, primer, or UV varnish is thin relative to the thickness of the substrate. The accompanying drawings illustrate applications of ink, primer, and UV varnish to be much thicker relative to the thickness of the substrate for clarity. The accompanying drawings illustrate the thickness of the substrate to be much thicker than the thickness of the substrate would be in most applications. The accompanying drawings illustrate applications of ink, primer, and UV varnish to be much thicker than the thickness of these applications would be in most applications.

### DETAILED DESCRIPTION OF THE INVENTION

The present invention relates to sequentially primed printed substrates. The benefits of the invention can be enjoyed in virtually all applications in which printed substrates can be used. Printed substrates can be used in product packaging, containers, wallpaper, fastening tape, decorative tape, food wraps, paper products, wipes, and the like. The invention will be disclosed herein with respect to the Figures as a preferred embodiment of product packaging.

As used herein, the term “substrate” refers to any material that can be printed on. Substrates include, but are not limited to, materials such as plastics, plastic films, fabrics, papers, polymer films, non-woven webs or fabrics, woven webs or fabrics. Woven and non-woven webs can be formed from monocomponent fibers, bicomponent fibers, multiconstituent fibers, capillary channel fibers, and the like. Substrates also include blown or cast film materials in a blend of low density polyethylene and linear low density polyethylene, metallocenes, ethylene vinyl acetate, surlyn, polyethylene terephtalate, biaxially oriented polypropylene, and nylon. A substrate can be two or more substrates laminated together. A substrate can be metalized. A substrate can be pigmented. A substrate can be clear. A substrate can be opaque.

As used herein, the term “film” designates a film having a caliper that is suitable for use in packages such as bags and pouches for consumer goods as well as part of consumer goods themselves. Preferably, the film is a thin film, such as, for example, film calipers from about 10 to about 250 microns. Thin films may be made of a polyolefin resin. Many different blends of components are used in the polyolefin and components are selected for a variety of properties such as strength and opacity. Polyethylene (e.g., Low Density Polyethylene LDPE, Linear Low Density Polyethylene LLDPE, High Density Polyethylene HDPE, Medium Density Polyethylene MDPE, Metallocene Polyethylene mPE, Ethyl Vinyl Acetate EVA and mixtures thereof) and polypropylene, and blends thereof are two types of materials that are often used to manufacture thin films. Thin films may be manufactured using blown film, cast film, and extrusion base processes. Any of the aforesaid may comprise bio derived (in part or whole) polymers or monomers that are then subject to polymerization. It should be recognized that any of the aforementioned synthetic polymers may be formed by using a combination of monomers derived from renewable resources and monomers derived from non-renewable (e.g., petroleum) resources.

A flexible film may be provided in the form of discrete sheets or pieces of film, or in the form of a continuous web of film. The film may be presented as a wound roll of material. The presented film can be described as having a first side and a second side. The dimensions of the presented film are such that the thickness dimension of the web is substantially smaller than the length or breadth of the presented film. The wound roll of film web may be unwound and passed through a converting process including the steps of the disclosed method using web handling equipment for the purposes of unwinding the roll of web, carrying the web and maintaining the desired tension in controlling the moving web through the process steps. The terms “thin film” or “plastic film” or “flexible film” or just “film” are used interchangeably and what is meant herein is any film made essentially from thermoplastic material.

As used herein, the term “ink” refers to a material laid down on a substrate via common printing processes, its main function being to convey a color. Often inks are in a liquid form and contain at least one pigment or dye. Chemically, many inks are suspensions of organic or inorganic pigments, which are embedded in a polymer resin for stabilization. The carriers of these systems are solvents. Solvents can be water, hydrocarbons or mixtures thereof (e.g. alcohol, esters, acetates, ethers), drying is done thermally or via infrared (IR).

Ink can be placed using any methods known in the art including but not limited to gravure printing, flexographic printing, and offset printing, letter press, lithography, plateless, post press, digital and screen printing. Gravure printing is the direct transfer of liquid ink to substrate from a metal image carrier. The image is lower than the surface of the image carrier base. Flexography printing is the direct transfer of liquid ink to substrate from a photopolymer image carrier. The image is raised above the surface of the image carrier base. Offset printing is the indirect transfer of paste ink to substrate from a rubber ‘blanket’ that is intermediate to substrate and the thin metal image carrier. Examples of plateless printing include electronic printing, ink jet printing, magnetography, ion deposition printing, direct charge deposition printing, and the Mead Cycolor Photocapsule process.

Solvent-based inks can be dried thermally. Once a first ink layer is applied to the film, the solvent contained therein is allowed to or caused to evaporate. Where a printing system such as that described in the aforementioned patent is employed, the solvent preferably is caused to evaporate by means of heat or forced air so as to reduce the amount of time prior to the next ink layers are applied. Once the first ink layer is applied, all subsequent ink layers (if any) are applied in a similar, standard manner.

As used herein, “radiation curing” refers to exposing a material to ionizing radiation. This polymerizes and/or crosslinks the materials. In the case of the varnish of the present invention, the curing provides a hardened “shell” over the underlying printed markings. Useful types of ionizing radiation include UV-light, electron beam (e-beam), X-ray, corona discharge, and the like, with the former being preferred. Regardless of source, the dose of ionizing radiation preferably is sufficiently high to polymerize and crosslink the varnish sufficiently yet not so high so as to degrade the underlying printed markings or the surface of the film

As used herein, a “printed film” refers to a film having one or more layers of ink located on one side, or both sides of the film. To bring down inks on a film, it is commonly done in continuous mode with a set of print cylinders and rollers that transfer, distribute and dry the ink particles on the material to be printed. Various printing technologies exist, such as but not limited to flexography, gravure, screen, digital and offset.

As used herein, the term “primer” refers to a material laid down on a substrate using common printing processes, its main functions being to create (a) adhesion (b) a barrier between the material layer below and a following layer printed thereafter. In this case, promoting “adhesion” means creating a firm connection between the material layer below and a following layer printed thereafter, such that the materials are connected to each other and do not separate under normal usage. Chemically, primers are suspensions of polymer resins in a solvent matrix (mixtures of several hydrocarbons) or suspensions of polymer resins in water. Primers can come as 1-component or 2-component systems, with or without polymerization (thermal drying only). Polymerisation can be triggered chemically (e.g. iso cyanate and urethane), or by radiation (radical or kationic, radiation sources, UV, Electron-beam or other).

As used herein, the term “varnish” refers to a pigment-free, usually liquid, material. Generally, varnish has three main ingredients: (1) resin, which is a binder that can be soluble or in a solvent (2) solvent or water to dissolve the resin, and (3) additives. Preferably, the varnish is UV-curable, meaning it is cured using ultraviolet radiation.

As used herein, the term “pigmented substrate” refers to a substrate that is colored.

As used herein, the term “low gauge” refers to a substrate having a thickness less than 250 microns.

As used herein, the term “indicia” refers to markings or indications that can be used to convey a message. The message conveyed can be an indication of source, the characteristics of a product in a package, the quantity of a product in a package, the quality of a product in a package, or any other message. Indicia can be a single color such as a light pink to indicate the source of a particular building insulation. Indicia can be a symbol such as a graphic resembling a target used for training archers to indicate a particular retail store. Indicia can be text in any language or combination of languages representative of verbal communication. Indicia can be patterns of colors, lines, or combinations thereof such as that often appearing on Scottish kilts and possibly used to indicate the source of an adhesive tape. Indicia can be illustrations of tangible objects such as an apple indicating the source of a particular brand of computer. Indicia can be artwork depicting tangible objects or imaginary compositions or any kind of marking. A single dot of a single color can be indicia. Indicia can be the type, texture, smell, or sound when rustled of the material used to form a package. Indicia can be a combination of any and all of the indicia described previously.

As used herein, the term “cleaning product” refers to detergents, laundry detergents in a liquid or powdered form, dishwasher detergents in a liquid or powdered form, or any other liquid, suspension, emulsion, powder, or granules used for cleaning.

As used herein, the terms “first side” and “second side” refer to the major planar like surfaces of the substrate. For example a classic sheet of notebook paper can be considered to have a first side and a second side available for writing upon. The surfaces of the first side and second side can be flat or curved or a combination of flat and curved surfaces.

Although the present invention is not limited to consumer products falling within specific categories, a representative, non-limiting list of product categories that the present invention is useful for includes antiperspirants, baby care, colognes, commercial products (including wholesale, industrial, and commercial market analogs to consumer-oriented consumer products), cosmetics, deodorants, dish care, feminine protection, hair care, hair color, health care, household cleaners, incontinence care, laundry, oral care, paper products, personal cleansing, disposable absorbent articles, pet health and nutrition, prescription drugs, prestige fragrances, skin care, snacks and beverages, special fabric care, shaving and other hair growth management products, small appliances, devices and batteries. A variety of product forms may fall within each of these product categories. Exemplary product forms and brands are described on The Procter & Gamble Company's website www.pg.com, and the linked sites found thereon. It is to be understood that consumer products that are part of product categories other than those listed above are also contemplated by the present invention, and that alternative product forms and brands other than those disclosed on the above-identified website are also encompassed by the present invention.

Exemplary products within the laundry category include detergents (including powder, liquid, tablet, and other forms), bleach, conditioners, softeners, anti-static products, and refreshers (including liquid refreshers and dryer sheets). Exemplary products within the oral care category include dentifrice, floss, toothbrushes (including manual and powered forms), mouth rinses, gum care products, tooth whitening products, and other tooth care products. Exemplary feminine protection products include pads, tampons, interlabial products, and pantiliners. Exemplary baby care products include diapers, wipes, baby bibs, baby change and bed mats, and foaming bathroom hand soap. Exemplary health care products include laxatives, fiber supplements, oral and topical analgesics, gastro-intestinal treatment products, respiratory and cough/cold products, heat delivery products, and water purification products. Exemplary incontinence care products include diapers, pads, and liners. Baby care, incontinence care and feminine protection products may be marketed for purposes of managing urinary and/or fecal incontinence; absorbing or containing bodily wastes; toilet training; and/or protecting skin. Exemplary paper products include toilet tissues, paper towels, and facial tissues. Exemplary hair care products include shampoos, conditioners (including rinse-off and leave-in forms), and styling aids. Exemplary household care products includes sweeper products, floor cleaning products, wood floor cleaners, antibacterial floor cleaners, fabric and air refreshers, and vehicle washing products. Skin care products include, but are not limited to, body washes, facial cleansers, hand lotions, moisturizers, conditioners, astringents, exfoliation products, microderm abrasion and peel products, skin rejuvenation products, anti-aging products, masks, UV protection products, and skin care puffs, wipes, discs, clothes, sheets, implements and devices (with or without skin care compositions).

The communication may be used with respect to services. Exemplary services include: car wash, dry cleaning, hair salons, human and pet beauty and grooming salons, laundry service, food and beverage services including coffee service, barber shops, carpet and floor cleaning and washing services, maid and janitorial services, as well as architectural decorating services and products.

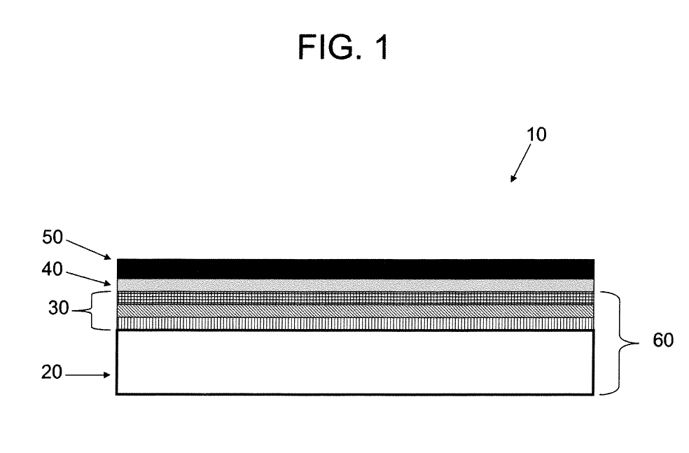

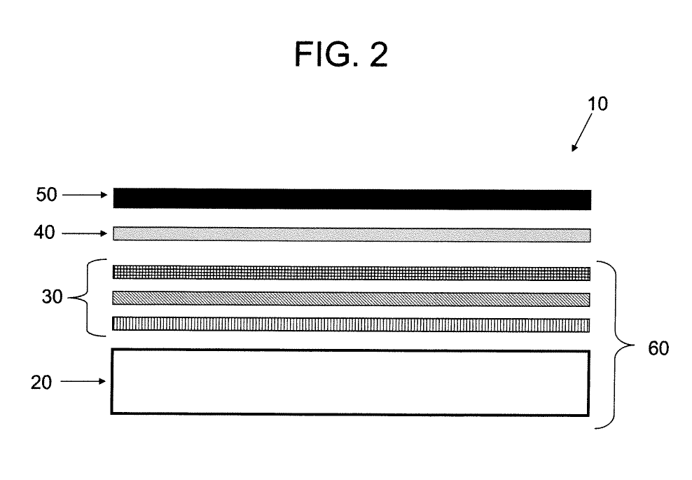

The present invention can be best understood by examining cross sections of sequentially primed printed substrates. A cross section of a sequentially primed printed substrate 10 is shown in FIG. 1. The sequentially primed printed substrate 10 can be comprised of a substrate 20, one or more ink layers 30, a primer layer 40 and a UV varnish 50. Sequentially primed printed substrates used in product packaging can be described as having an exterior surface and an interior surface. The exterior surface is the surface of the package facing the consumer. The interior surface is the surface of the package facing the product contained within the package.

FIG. 1 is a cross section of a sequentially primed printed substrate 10. As shown in FIG. 1, one or more ink layers 30 can be placed on substrate 20. Together, substrate 20 and one or more ink layers 30 can form a printed substrate 60. As shown in FIG. 1, the first application can be one or more ink layers 30. Primer 40 can be placed on printed substrate 60. UV varnish 50 can be placed on primer 40.

Substrate 20 can be several types of flexible film used for the packaging of consumer goods. One or more ink layers 30 can be selected from a variety of inks, for example, inks from printing ink series NC 116-8 available from Siegwerk, Siegburg, Germany or similar Primer 40 can be INX 1421063, available from company INX, West Chicago. UV varnish 50 can be INX UV varnish 1396894, available from company INX, West Chicago.

Substrate 20 can be any thickness. Preferably the thickness of substrate 20 is less than 6000 microns. More preferably the thickness of substrate 20 is less than 1000 microns. Even more preferably the thickness of substrate 20 is less than 500 microns. Even more preferably the thickness of substrate 20 is less than 250 microns. Most preferably, the thickness of substrate 20 is less than 100 microns.

For polymeric film substrates, preferably the thickness of the substrate 20 is less than 250 microns. More preferably, for polymeric film substrates the thickness of the substrate 20 is less than 150 microns. Most preferably, for polymeric film substrates the thickness of the substrate 20 is less than 100 microns.

FIG. 2 is an exploded cross sectional view of the sequentially primed printed substrate 10 of FIG. 1.

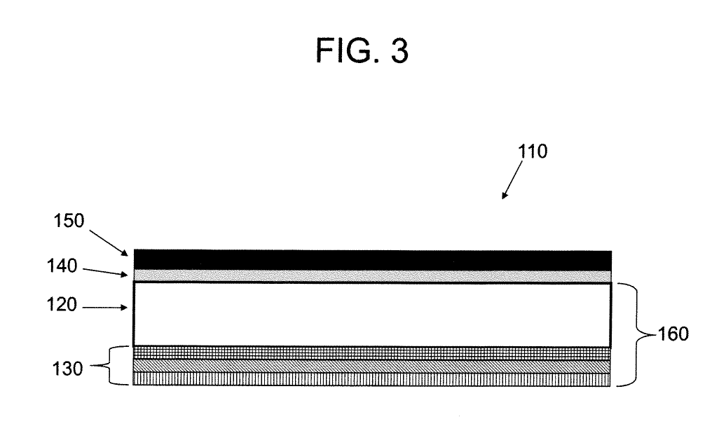

FIG. 3 is a cross section of a sequentially primed printed substrate 110. As shown in FIG. 3, one or more ink layers 130 can be placed on substrate 120. Together, substrate 120 and one or more ink layers 130 can form a printed substrate 160. As shown in FIG. 3, the first application can be one or more ink layers 130. Primer 140 can be placed on printed substrate 160, on the side of the printed substrate 160 without one or more ink layers 130. UV varnish 150 can be placed on primer 140. The sequentially primed printed substrate 110 shown in FIG. 3 can be formed into a package and the printed substrate can be oriented such that the printed substrate 160 is on the interior surface of a package. In the alternative, the printed substrate 160 can be the exterior surface of a package.

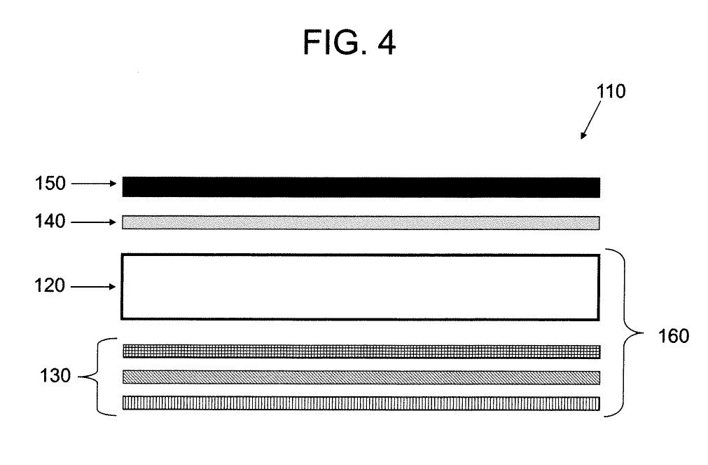

FIG. 4 is an exploded cross sectional view of the sequentially primed printed substrate 110 of FIG. 3.

The laminates and monolayer films of the present invention are particularly suitable for adapting to consumer needs for an attractive package. For example the package may be given visual features, including printing effects, metallization effects, and holographic effects.

To improve the adhesion of the ink to the surface of the substrate film, the surface of the substrate film may be treated or modified before printing. Surface treatments and modifications include: i) mechanical treatments, such as corona treatment, plasma treatment, and flame treatment, and ii) primer treatment. Surface treatments and modifications are known to those of skill in the art.

Table 1 shows some preferred materials and processing conditions.

TABLE 1

| | pre-printed ink | Step 1: Priming | Step 2: Varnishing |
|---|---|---|---|
| Material | Solvent based | INX Primer | INX UV varnish |
| | inks (multiple | No. 1421063-Z19 | No. 1396894-3421 |
| | suppliers) | (development | (ProCure ™ |
| | | No. 1383788) | KCC5113) |
| Application | Artwork on | Printed over the | Application on top |
| Method | surface printed | artwork to a) | of the primed areas |
| | films | create a barrier | to create a special |
| | | and b) ensure | decoration effect |
| | | proper adhesion | (separate process |
| | | of UV varnish | step) |
| Printing | Common printing | Gravure printing | Flexo printing |
| process & | processes see | Cylinder 60 | anilox cylinder 80 |
| parameters | below overall | lines/cm, 40° | lines/cm, 11.3 |
| | description | grid angle, | (theor. volume) |
| | | tunnel 30 μm, | print width 250 mm, |
| | | depth 180 μm | full coverage, speed |
| | | Doctor blade | 50-100 m/min |
| | | pressure 2.5 bar | dry coat weight 4.8 |
| | | Impression roller | gsm |
| | | pressure 3-6 bar | |
| | | Print width | |
| | | 290 mm, full | |
| | | coverage, speed | |
| | | 45-50 m/min | |
| | | Dry coat weight | |
| | | 0.9 gsm | |
| # of colors | usually 1 up to 8 | 1 | 1 |
| Ink/Primer | Solvent, 1 | Solvent, 1 | UV |
| system | component (1 k) | component (1 k) | |
| Binder | NC | PU (Polyure- | |
| | (nitrocellulose) or | thane)-10-20% | |
| | PVB (Polyvinyl | weight | |
| | butyral) or PVC | | |
| | (Polyvinyl | | |
| | chloride)-5-25% | | |
| | weight | | |
| Pigment(s) | 10-30% | 0% | 0% |
| Coupling | 0.5-5% (silanes) | 0% | |
| agent | | | |
| Plasticizer | 10-40% (e.g. | usually <10% | |
| | poly urethane) | | |
| Solvent | usually 25-55% | 10-30% ethyl | n.a. |
| (carrier) | (combinations | acetate | |
| | of water, hydro- | 3-7% propyl | |
| | carbon solvents, | acetate | |
| | solvents and | 3-7% propan-2- | |
| | mixtures thereof. | ol | |
| | Solvents may | 1-5% 2- | |
| | include acetates | butoxyethanol | |
| | (e.g ethyl-or | | |
| | propyl acetate), | | |
| | ethanol, propanol, | | |
| | etc.) | | |
| Other | | | 15-40% Trimethylol- |
| | | | propane triacrylate |
| | | | 15-40% Phenol, 4,4′- |
| | | | (1-methylethylidene) |
| | | | bis-, polymer with |
| | | | (chloromethyl)oxir- |
| | | | ane, 2-propenoate |
| | | | 15-40% (1-methyl- |
| | | | 1,2-ethanediyl)bis |
| | | | [oxy(methyl-2,1- |
| | | | ethanediyl)] |
| | | | diacrylate |
| | | | 10-30% Acrylate |
| | | | Oligomer |
| | | | 5-10% hexane-1, |
| | | | 6-diol diacrylate |
| | | | 5-10% Acrylate Ester |
| | | | Monomer |

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A substrate comprising:
a. a printed film wherein a film has all or a portion of its surface covered by an ink;
b. a layer of pigment-free primer covering at least some portion of the film, the ink, or both the film and the ink; and
c. a radiation-cured varnish covering some portion of the primer;
wherein the primer promotes adhesion between the ink and the radiation cured varnish.

2. The substrate of claim 1 wherein the film is a polyolefin film.

3. The substrate of claim 1 wherein the film is selected from the group consisting of polyethylene, polypropylene and polyester films.

4. The substrate of claim 1 wherein the film is not paper.

5. The substrate of claim 1 wherein the ink is water-based or solvent-based and the primer is water-based or solvent-based.

6. The substrate of claim 5 wherein the ink is solvent-based and the solvent is selected from the group consisting of olefin acetyl esters, olefin alcohols and olefin oxy ethanols.

7. The substrate of claim 1 wherein the primer covers at least a portion of both the ink and the film.

8. The substrate of claim 1 wherein the primer covers all areas of the film and/or the ink where the radiation-cured varnish is located.

9. The substrate of claim 1 wherein the radiation-cured varnish is pigment-free.

10. A method of forming a printed substrate comprising the steps of:
a. providing a film;
b. applying one or more layers of ink to the film;
c. drying the one or more layers of ink;
d. applying a layer of primer to the ink and/or film;
e. drying or curing the layer of primer;
f. applying a layer of radiation-curable varnish to the primer-coated film; and
g. curing the varnish.

11. The method of claim 10 wherein the film is not paper.

12. The method of claim 10 wherein the film is a polyolefin film.

13. The method of claim 10 wherein the film is selected from the group consisting of polyethylene, polypropylene and polyester films.

14. The method of claim 10 wherein the ink is water-based or solvent-based and the primer is water-based or solvent-based.

15. The method of claim 14 wherein the ink is solvent-based and the solvent is selected from the group consisting of olefin acetyl esters, olefin alcohols and olefin oxy ethanols.

16. The method of claim 10 wherein the primer covers at least a portion of both the ink and the film.

17. The method of claim 10 wherein the primer covers all areas of the film and/or the ink where the radiation-curable varnish is located.

18. The method of claim 10 wherein the radiation-curable varnish is pigment-free.

19. A method of forming a printed substrate comprising the steps of:
a. providing a film printed with one or more layers of ink;
b. applying a layer of primer to the ink and/or film;
c. drying or curing the layer of primer;
d. applying a layer of radiation-curable varnish to the primer-coated film; and
e. curing the varnish.

20. The method of claim 19 wherein the primer covers all areas of the film and/or the ink where the radiation-curable varnish is located.

21. The method of claim 19 in which a pattern is cast into the wet varnish prior to its curing by means of temporarily applying onto it
a. another transparent film with an embossed or de-bossed surface structure, or
b. a transparent forming template made from any rigid material with an embossed or de-bossed surface structure

22. The method of claim 10 in which a pattern is cast into the wet varnish prior to its curing by means of temporarily applying onto it
a. another transparent film with an embossed or de-bossed surface structure, or
b. a transparent forming template made from any rigid material with an embossed or de-bossed surface structure
